(19) United States
(12) Patent Application Publication
(10) Pub. No.: US 2017/0221070 A1
(43) Pub. Date: Aug. 3, 2017

(54) METHOD AND SYSTEM FOR SUPPORTING OPERATIONS IN RETAIL STORES

(71) Applicant: ASDA STORES LIMITED, Leeds (GB)

(72) Inventor: Philip Alexander Stout, Atherton (GB)

(21) Appl. No.: 15/515,558

(22) PCT Filed: Oct. 1, 2015
(86) PCT No.: PCT/GB2015/052873

§ 371 Date: Mar. 29, 2017

(30) Foreign Application Priority Data
Oct. 1, 2014 (GB) 1417360.3

(51) Int. Cl. G06Q 30/00; G06Q 10/08

(52) U.S. Cl. CPC G06Q 30/014; G06Q 10/087

(57) ABSTRACT

A system for supporting product recall events includes a controlling server 60 coupled to local servers 20 and in-store portable devices 30 which may be wearable devices such as smart glasses or smart watches. The controlling server 60 receives a recall notification message 5 from a source device 50 and distributes a command 52 across a network 40 to local servers 20 which produce task messages 53 for the wearable devices 30. Evidence messages 54 containing images captured by the wearable devices 30 are returned via the local servers 20 to the controlling server 60.

### RELATED APPLICATIONS

The present application claims priority under the Paris Convention to application number 1417360.3 entitled “Method and System for Supporting Operations in Retail Stores” filed on 1 Oct. 2014 in United Kingdom.

### BACKGROUND

### Technical Field

The present application relates in general to the field of systems and methods for supporting operations in a retail store. Particularly, the present application relates to a system and a method for supporting product recall events in retail stores.

### Description of Related Art

Modern retail stores sell a wide variety of products, including foodstuffs, home and kitchen goods, electronic goods, clothing, sporting goods and so on. Occasionally, errors occur in the manufacture or supply of the products, which may mean that the products should not be sold to the public. In some cases, the products may be of substandard quality, and sales thereof may adversely affect the reputation of the manufacturer or supplier of the product. In other more serious cases the products may be harmful to the public. In either case, there is a great desire to ensure that customers do not purchase any defective products.

However, there is a problem in that errors may not be detected until after the products are delivered to the retail store and displayed for sale on display units in the store. In such an instance, the manufacturer or supplier may request that the retailer takes the products off sale and returns or disposes of the products, which is known in the art as product recall.

Due to the potentially severe consequences of an incomplete product recall, it is necessary for retailers to diligently perform the product recall process. However, there is currently no support for achieving the product recall. In particular, there is a need to develop better technological assistance for product recalls.

It is an aim of the present invention to address at least some of the above difficulties, or other difficulties which will be appreciated from the description below. One example aim is to provide convenient and cost effective technological systems and methods which will assist the process of recalling products in retail stores.

### SUMMARY

According to the present invention there is provided an apparatus and method as set forth in the appended claims. Other features of the invention will be apparent from the dependent claims, and the description which follows.

In one example there is described a system for supporting product recall events. The system includes a controlling server coupled to local servers and in-store portable devices which may be wearable devices such as smart glasses or smart watches. The controlling server receives a recall notification message from a source device and distributes a command across a network to local servers which produce task messages for the wearable devices. Evidence messages containing images captured by the wearable device are returned via the local servers to the controlling server.

In one example there is described a system for supporting product recall events in a retail store network, comprising: a controlling server configured to receive a product recall notification message comprising product information that identifies one or more product items, and in response to generate a product recall command message; a plurality of local servers each coupled to the controlling server over an intra-site network, wherein the local servers are each configured to receive the product recall command message and in response to generate a product recall task message; an in-store portable device coupled to a respective one of the local servers over a local network, wherein the in-store portable device is configured to receive and display the product recall task message received from the respective local server and to provide a product recall evidence message providing evidence of a product recall event, wherein the in-store portable device is configured to transmit the product recall evidence message to the respective local server and the respective local server is configured to transmit the product recall evidence message to the controlling server.

In one example, the in-store portable device is further configured to capture at least one evidential image providing evidence of the product recall event, and wherein the product recall evidence message comprises the at least one evidential image.

In one example, the in-store portable device is further configured to generate image metadata associated with the at least one evidential image, and wherein the product recall evidence message comprises the generated image metadata.

In one example, the generated image metadata includes at least one of a time at which the evidential image was captured and a location in the retail store at which the evidential image was captured.

In one example, the in-store portable device is further configured to capture the at least one evidential image before the product recall event has occurred.

In one example, the in-store portable device is further configured to capture the at least one evidential image after the product recall event has occurred.

In one example, the in-store portable device comprises a wearable device configured to be worn by a user whilst in use.

In one example, the plurality of local servers is each further configured to generate store-specific metadata, and wherein the product recall task message comprises the store-specific metadata.

In one example, the store-specific metadata comprises at least one of a location of the one or more product items in the retail store, and an image of a display unit on which the one or more product items are displayed in the retail store.

In one example, the product information comprises at least one of the retailer's stock keeping number (SKU), a batch number of the recalled product, and a description of the fault in the product.

In one example, the product recall command message comprises at least one of a priority level, and a deadline for performing the product recall event.

In one example, the in-store portable device is configured to transmit the product recall evidence message in response to a user command

In one example there is described a method of supporting operations in retail stores, comprising: receiving by a controlling server a product recall notification message comprising product information that identifies one or more product items; generating by the controlling server a product recall command message in response to the received product recall notification message and transmitting the product recall command message to a plurality of local servers coupled to the controlling server; producing by each local server a product recall task message in response to the received product recall command message and transmitting the product recall task message to an in-store portable device coupled to a respective local server; providing by the in-store portable device an evidence message gathering evidence of a product recall event and transmitting the evidence message to the respective local server; and transmitting by the local server the generated evidence message to the controlling server.

One example includes capturing by the in-store portable device at least one evidential image providing evidence of the product recall event, and including the at least one evidential image in the evidence message.

One example includes generating image metadata associated with the at least one evidential image, and including the generated image metadata in the evidence message.

In one example, the image metadata includes at least one of a time at which the evidential image was captured and a location in the retail store at which the evidential image was captured.

One example includes capturing the at least one evidential image before the product recall event has occurred.

One example includes capturing the at least one evidential image after the product recall event has occurred.

In one example the in-store portable device comprises a wearable device worn by a user whilst in use.

One example includes generating, by each of the plurality of local servers, store-specific metadata, and including the store-specific metadata in the product recall task message.

In one example, the store-specific metadata comprises at least one of a location of the one or more product items in the retail store, and an image of a display unit on which the one or more product items are displayed in the retail store.

In one example, the product information comprises at least one of the retailer's stock keeping number (SKU), a batch number of the recalled product, and a description of the fault in the product.

In one example, the product recall command message comprises at least one of a priority level and a deadline for performing the product recall event.

In one example there is provided a wearable device which is configured to operate as described herein.

In one example there is provided a server device which is configured to operate as described herein. The server device may be a local server or a controlling server, as described herein.

In one example there is provided a computer readable medium having instructions recorded thereon which when executed cause a computer device to perform any of the methods described herein.

### BRIEF DESCRIPTION OF THE DRAWINGS

For a better understanding of the invention, and to show how example embodiments may be carried into effect, reference will now be made to the accompanying drawings in which:

FIG. 1 is a schematic view of a retail store in which an example system may operate;

FIG. 2 is a schematic view of an example product recall support system;

FIG. 3 is a further schematic view of an example product recall support system;

FIG. 4 is an example display provided by a wearable device; and

FIG. 5 is a flowchart of an example method to support product recalls.

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

### DETAILED DESCRIPTION OF EXAMPLE EMBODIMENTS

At least some of the following exemplary embodiments provide an improved system and method suitable for monitoring display units in a retail store. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment or example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

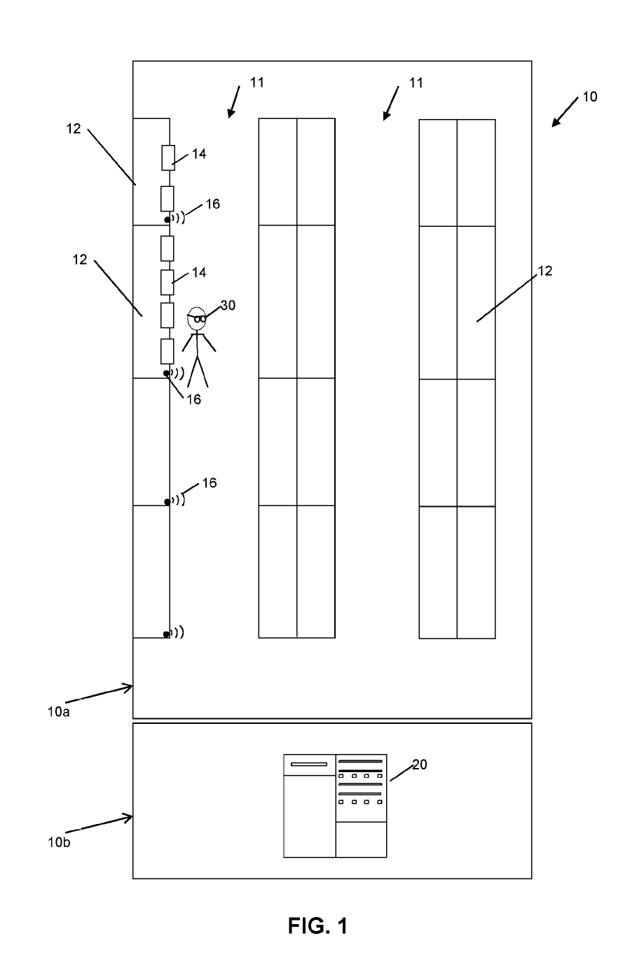

FIG. 1 shows a schematic view of a physical environment in which an exemplary embodiment of the invention may operate. The physical environment may comprise a retail store 10. The retail store 10 typically comprises a sales area 10a, in which goods are displayed, and an operational area 10b, in which further stock may be held, and infrastructure for the maintenance of the sales area is installed. The operational area 10b may include a server 20, which will be described in further detail below. The retailer's computer network in practice may have many hundreds of stores with various local servers linked to one or more central control computers operated by the retailer, e.g. in their head office. These central control servers may in turn communicate across suitable communication networks with computer systems of suppliers and manufacturers.

The sales area 10a typically includes a plurality of aisles 11, wherein each aisle further comprises a plurality of display units 12. In one example, a display unit 12 may further be comprised of a plurality of shelves (not shown). The display unit 12 may include one or more product labels 14 arranged to be prominently visible to a customer. In one example, the product labels 14 are shelf edge labels as will be familiar to those skilled in the art. The product label 14 may be a printed label. The label 14 may be printed with ink on a substrate such as paper.

Each display unit 12 displays one or more product items. For example, a display unit 12 might display bottles of soft drink A, bottles of soft drink B and cans of soft drink C, amongst other items.

The configuration of the retail store 10 is a matter of some importance, because the layout of the aisles 11 and configuration of the display units 12 has the potential to both positively and negatively impact on sales. Particularly, the layout of the items on the display units 12 is often carefully planned by staff who are trained to maximise the visual appeal of such units 12. However, it will be understood that many configurations of retail store layout and display unit layout are possible, and the embodiments described below are not dependent upon any particular layout or configuration.

FIG. 1 also shows a wearable device 30 which will be described in further detail below. The wearable device 30 is suitable to be worn by a user. In the example embodiments, the user or operator is a member of staff of the retail store.

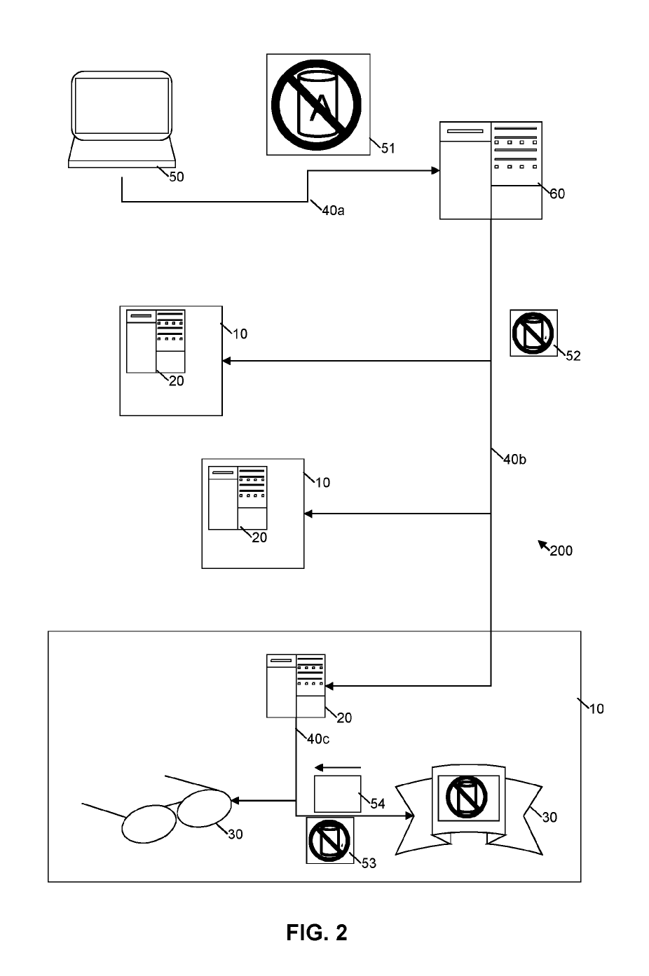

FIG. 2 is a schematic view of an example product recall support system 200. A source device 50 is coupled to a controlling server 60 over a first network 40a. The controlling server 60 is coupled to a plurality of local servers 20 over a second network 40b. The local servers 20 each may be coupled to local in-store portable devices 30 over a third network 40c.

In this example, the controlling server 60 may be connected to a large number of individual local servers 20 over the communication network 40b. In one example, each local server 20 is provided within a respective retail store location 10. Meanwhile, the controlling server 60 may be provided, for example, in a head office location of the retailer. Thus, the controlling server 60 may be coupled to a large number of local servers 20 which are in many different geographically diverse locations, e.g. spread out across the country.

In use, the example system 200 is configured to receive a product recall notification message 51 from the source device 50, such as over the first communication network 40a. The notification message 51 may be received from any suitable source device. In one example, the notification originates from a remote source device such as a computer system operated by a manufacturer or supplier of the products being offered for sale by the retailer. Alternatively, the notification message 51 may be received from an intermediary, such as the computer system of a wholesaler or logistics partner of the retailer. In further examples, the notification message 51 may originate from a government public health organisation or consumer protection body. In still further examples, the notification message 51 may originate from a user terminal with a local area network of the retailer, e.g. at their head office location. The source device 50 may suitably provide a user interface which allows the notification message to be generated and sent to a controlling server 60.

The notification message 51 conveniently includes product identification information relevant to the product being recalled. In one example, the information may comprise the retailer's stock keeping number (SKU), or another unique identifier of the recalled product. In a further example, the details may comprise a batch number of the recalled product. The details may also comprise relevant human readable information which may describe the nature of the fault in the product. Furthermore, the details may comprise relevant human readable information which is intended to aid a member of retail store staff identify the product. For example, the relevant human readable information may state “Error in labelling—best before date missing”. The member of retail store staff may then more easily identify the product to be recalled by identifying that the label does not comprise the best before date.

In one example, the controlling server 60 is configured to distribute a recall command message 52 to one or more of the plurality of the local servers 20 in one or more of the many retail store locations 10. The controlling server 60 may generate the recall command message 52 based on the information provided in the notification message 51. The controlling server 60 may also add further information or commands to the notification command message, such as a priority level, or a deadline for performing the command. These and other specific details may adapted according to the needs of a specific implementation of the example system.

FIG. 2 shows one of the store locations 10 in greater detail for ease of illustration. Within the store location 10, the local server 20 is suitably coupled to one or more in-store portable devices 30 over the local communication network 40c. Those skilled in the art will be familiar with many suitable specific forms of the in-store local communication network 40c, which may be a stand-alone network or may be a continuation of the wider intra-store communication network. In this example, the retail store server 20 is configured to distribute the received product recall command message 52 as a task message 53 to one or more wearable devices 30.

The wearable device 30 may be configured to receive the task message 53 and display the task message to be appreciated by the user of the wearable device 30. The wearable device 30 may further be configured to record evidence of the completion of the product recall event. The wearable device 30 may still further be configured to transmit the evidence to the store server 20 in an evidence reply message 54. The store server 20 may be configured to transmit the received evidence message 54 back to the controlling server 60.

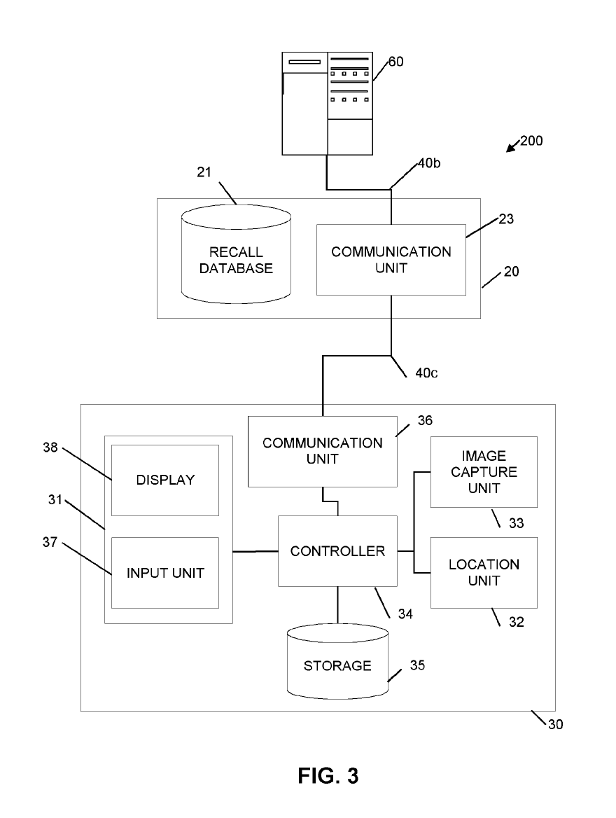

FIG. 3 shows a more detailed schematic view of the example product retail system 200. The system 200 comprises a store server 20, which holds a recall database 21. Conveniently, the recall database 21 stores recall information related to one or more product recall events. The recall information may comprise the product recall details received as part of the product recall notification message 51.

In one example, the recall information may further comprise store-specific metadata. Particularly, the store-specific metadata may comprise a location of the recalled product in store. For example, the store-specific metadata may give a specific aisle 11, display unit 12 and/or shelf on which the recalled product is stored. The store-specific metadata may further comprise a reference image of the display units 12, which shows the position of the recalled item on the display unit. Such images are also known as planograms or POGs. The planogram images may be photographs of an example physical display unit 12. Equally, the images may be concept diagrams or other images generated in the process of planning the configuration of the display units 12.

In one example, the recall database 21 may be further configured to store one or more evidential images associated with a product recall command message 52. The images may be captured by the wearable device 30 in accordance with the example embodiments described below.

In one example, the store server 20 and the wearable device 30 may be linked by the communication network 40c. The network may take any suitable form, including secure wired and/or wireless communication links, as will be familiar to those skilled in the art.

The store server 20 may further include a communication unit 23, which is operable to manage communications over the network 40c between the server 20 and the wearable device 30. The server communication unit 23 may also manage communication between the server 20 and other servers 20 and between the server 20 and the controlling server 60, over the network 40b. In one embodiment, information for updating data held at the server 20, such as the recall database 21, may be received from the controlling server 60 at the head office site, via the server communication unit 23. Particularly, a product recall command message 52 may be received from the controlling server 60.

Conveniently, the recall database 21 is held on the store server 20 to be accessible in use by the wearable device 30. However, it will be understood by those skilled in the art that the recall database 21 could instead be stored locally on the wearable device 30, e.g. by caching part or all of the stored information. Further, some or all of the database may be made available via any other suitable computing device as a distributed database.

Portable devices, such as tablets or smart phones, are well known. Such devices are designed and intended to be carried by a user, and are configured to be operated while in the hands of the user. By contrast, the wearable device 30 is also portable, but is further designed to be worn by a user during operation of the device. Advantageously, a wearable device may be configured to leave the user's hands free to perform other tasks while operating the device. The wearable device 30 may be smart glasses such as Google Glass™. Similarly, the wearable device may be a smart watch, configured to be worn on a user's wrist. In other examples, the wearable device 30 may be configured as a pendant or a hat. In yet further examples, the wearable device 30 may be constructed as a patch or as a thin film incorporated in or attached to clothing, or any other piece of clothing or accessory which is adapted to incorporate technological elements.

In one example, the wearable device 30 may comprise a controller 34, a storage 35, a user interface (UI) module 31, a communication unit 36, a location unit 32 and an image capture unit 33. The user interface module 31 may include an input unit 37 and a display 38.

The controller 34 is operable to control the wearable device 30, and may take the form of a processor. The storage 35 is operable to store, either transiently or permanently, any relevant data required for the operation and control of the wearable device 30. The communication unit 36 is operable to manage communications with the store server 20 over any suitable network.

The user interface module 31 is operable to input and output information to a user via one or more interfaces. In one exemplary embodiment the UI module 31 comprises an input unit 37 which is operable to receive instructions or commands from the user, and a display 38, which is operable to display at least one image to the user.

The display 38 may be a screen which is integral to the wearable device 30, but it is not limited thereto. In an embodiment where the wearable device 30 is a pair of smart glasses, the display 38 may be a Heads-Up Display (HUD) on the glass or a similar display projected into the field of view of the user.

The input unit 37 may receive user input by means of a button, a touch-screen unit, voice activation, gesture recognition or any other suitable means for receiving user instructions. The input unit 37 may also be operable to receive user input from a combination of these sources

The image capture unit 33 comprises a camera and is operable to capture an image.

The wearable device 30 may further comprise a location unit 32. The location unit 32 may be operable to detect the location of the wearable device 30. The location unit 32 may determine a current position of the device 30 within the retail store 10, such as by using an indoor positioning system. The indoor positioning system may employ the Global Positioning System (GPS) to establish the location of the device 30 within the retail store. The location unit 32 may instead or in addition employ proximity sensors using Bluetooth® low energy (e.g. iBeacons), WiFi, Near-Field Communication (NFC) or any other suitable locating means.

In one example, the display units 12 are adapted to contain locator beacons 16 as shown in FIG. 1, such as Bluetooth low energy beacons (e.g. iBeacons). The wearable device 30 may determine location using one or more of the locator beacons 16 (e.g. based on relative signal strength, or based on each beacon covering a certain floor area).

In one example, the locator beacons 16 may also act as a source of relevant information, which may be transmitted locally over the Bluetooth or other wireless connection to the wearable device 30. For example, a locator beacon unit is loaded with information relevant to the display unit 12 associated with that beacon. The locator beacon unit may now act as an intermediary on behalf of the server 20. The locator beacon unit may transmit the stored information relevant to the associated display unit 12 when the wearable device 30 is in the proximity of that locator beacon unit.

In a further exemplary embodiment, the location unit 32 may be configured to scan a visible machine-readable code, such as a barcode attached to a display unit 12, to establish the current position of the wearable device 30.

In one example, the code may be displayed on a shelf edge label. In further exemplary embodiments, the code may be a barcode attached to an item displayed on the display unit 12, and the location unit 32 may establish the current position of the device 30 based on the expected location of that item in a store layout plan.

In use, the system 200 receives the product recall command message 52 via the controlling server 60. It will be understood by those skilled in the art that in other examples the product recall command message 52 could alternatively be received directly from a manufacturer, supplier, or wholesaler system (not shown).

Next, the store server 20 stores the message in the recall database 21. In one example, the store server 20 additionally generates store-specific metadata and store in the recall database 21 with the recall command message 52. Particularly, the server 20 may determine a location of the recalled product in store, by looking up details of the product in a product database (not shown), and generate metadata detailing the location. In further examples, the server retrieves an image of the recalled product from the product database, and includes the image in the metadata. In still further examples, the server 20 retrieves an image of the display unit 12 on which the recalled product is displayed from a display unit database (not shown), and includes the image in the metadata.

Next, the store server 20 transmits a product recall task message 53, based on the product recall command message 52, along with the associated metadata, to the wearable device 30. The wearable device 30 stores the received task message 53 and metadata in the storage 35. In examples where the system comprises a plurality of wearable devices 30, the store server 20 may transmit the task message 53 to one or more of the wearable devices 30.

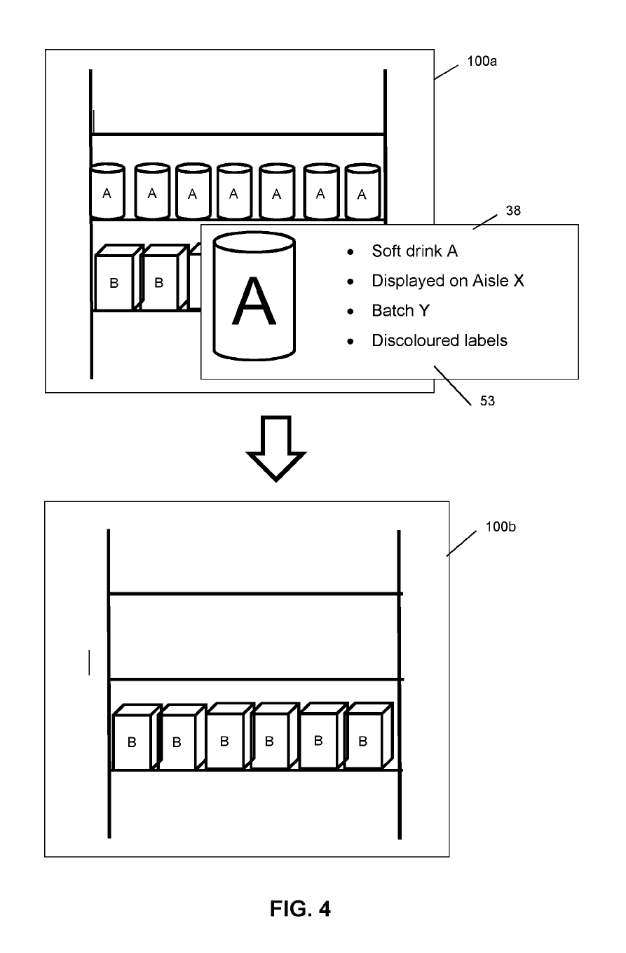

Next, as shown in FIG. 4, the wearable device 30 displays the task message 53 and associated metadata on the display 38. In examples where the wearable device 30 comprises smart glasses, the task message 53 may be shown in a field of view of the user. In examples where the wearable device 30 comprises a smart watch, the task message 53 may be shown on an electronic screen.

FIG. 4 shows a display unit 12a displaying recalled soft drink cans A. Advantageously, the task message 53 is displayed on the display 38 such that the user may perform an easy and effective visual comparison between the task message 53 and the display unit 12. Consequently, the user may more easily identify the recalled products.

In one example, the user controls the wearable device 30 to capture an image 100a of the display unit 12 which displays the recalled soft drink cans A. The image 100a may provide evidence of the display of the recalled soft drink cans A in store before recall.

In one example, the wearable device 30 is operable to generate image metadata associated with the image 100a. In one example, the generated metadata may include a time at which the image 100a was captured. In a further example, the generated metadata may include a location in the retail store at which the image 100a was captured, the location being determined by the location unit 32.

Next, the user removes the recalled products from the display unit 12.

Next, the user controls the wearable device 30 to capture an image 100b of the display unit 12 which has had the recalled soft drink cans A removed therefrom. The image 100b may provide evidence of the removal of the recalled soft drink cans A from the display unit 12.

In one example, the wearable device 30 is operable to generate image metadata associated with the image 100b. In one example, the generated metadata may include a time at which the image 100b was captured. In a further example, the generated metadata may include a location in the retail store at which the image 100b was captured, the location being determined by the location unit 32.

It will be understood by those skilled in the art that the captured images 100 are not limited to a single image 100a captured before recall and/or a single image 100b captured after recall. In other examples, further images 100 may be captured which show the display unit 12 from different vantage points. In further examples, further images 100 may be captured showing the display unit 12 in an intermediate state.

Next, the wearable device 30 transmits the image(s) 100 to the store server 20 in an evidence reply message 54. The evidence reply message 54 also includes the generated metadata. The store server 20 stores the evidence reply message 54 and the image(s) 100 and metadata enclosed therein in the recall database 21 as evidence of the recall.

In one example, the evidence reply message 54 may be transmitted to the server 20 in response to a user command received via the input unit 37 (e.g. a spoken command such as “OK Glass, Recall Done”). It will be understood that, in further examples, a plurality of evidence reply messages 54, each containing one or more images and generated metadata may be transmitted, rather than a single evidence reply message 54. Particularly, each evidence reply message 54 may contain one or more images 100 captured in close temporal proximity, and may be transmitted soon after the capture of the image 100.

Consequently, the recall database 21 is populated with information which provides evidence that the product recall has been performed accurately. Furthermore, the much of the information is automatically generated by either the store server 20 or the wearable device 30, requiring little user input.

In one example, the store server 20 subsequently transmits the evidence of the completed recall to the controlling server 60, over the network 40b.

The controlling server 60 may receive evidence of completed recall from each of the plurality of store servers 20 located in a plurality of retail stores 10. Consequently, the controlling server 60 may maintain a central audit database (not shown), comprising evidence of completed product recalls from a plurality of retail stores 10.

In a further example, the controlling server 60 may transmit the received evidence to a manufacturer system, such as replying to the original source device 50 or other appropriate recipient terminal.

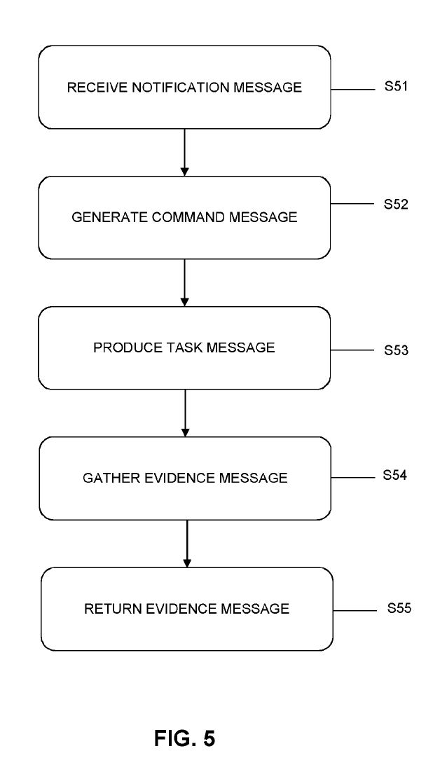

FIG. 5 is a flowchart of an exemplary method of supporting product recalls using the apparatus and system described herein.

Step S51 may include receiving a product recall notification message comprising product information that identifies one or more product items. The step S52 may include generating a product recall command message in response to the received product recall notification message and transmitting the product recall command message to a plurality of local servers 20. Conveniently, the steps S51 and S52 may be performed by the controlling server 60.

The step S53 may include generating by each local server 20 a product recall task message in response to the received product recall command message and transmitting the product recall task message to an in-store portable device 30 coupled to a respective local server 20. The step S54 may include providing by the in-store portable device 30 an evidence message providing evidence of a product recall event and transmitting the evidence message to the respective local server. The step S55 may include transmitting by the local server 20 the generated evidence message to the controlling server 60. The controlling server 60 may transmit a corresponding confirmation and/or evidence of the product recall event back to an originating source device 50.

The above-described systems and methods may advantageously enable retail store employees to more easily remove recalled products from display. The systems and methods may help to generate an audit trail, providing evidence that the recalled products have been removed correctly from display. Consequently, risks to the health and safety of customers are minimised. Furthermore, the inconvenience associated with a customer taking a recalled product to a point-of-sale only to find the product is not longer available for sale is averted.

Advantageously, the systems and methods make use of portable, wearable devices to allow the users to carry out their normal duties whilst operating the system. Supermarket staff have a wide variety of skills and backgrounds, and the above-described embodiments provide a simple and intuitive system which may be operate efficiently and reliably with minimal training.

Although a few preferred embodiments have been shown and described, it will be appreciated by those skilled in the art that various changes and modifications might be made without departing from the scope of the invention, as defined in the appended claims.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality.

In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination.

In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

1. A system for supporting product recall events in a retail store network, comprising: a controlling server configured to receive a product recall notification message comprising product information that identifies one or more product items, and in response to generate a product recall command message;
a plurality of local servers each coupled to the controlling server over an intra-site network, wherein the local servers are each configured to receive the product recall command message and in response to generate a product recall task message; and
an in-store portable device coupled to a respective one of the local servers over a local network, wherein the in-store portable device is configured to receive and display the product recall task message received from the respective local server and to provide a product recall evidence message providing evidence of a product recall event,
wherein the in-store portable device is configured to transmit the product recall evidence message to the respective local server and the respective local server is configured to transmit the product recall evidence message to the controlling server.

2. The system of claim 1, wherein the in-store portable device is further configured to capture at least one evidential image providing evidence of the product recall event, and wherein the product recall evidence message comprises the at least one evidential image.

3. The system of claim 2, wherein the in-store portable device is further configured to generate image metadata associated with the at least one evidential image, and wherein the product recall evidence message comprises the generated image metadata.

4. The system of claim 3, wherein the generated image metadata includes at least one of: a time at which the evidential image was captured; and a location in the retail store at which the evidential image was captured.

5. The system of claim 1, wherein the in-store portable device comprises a wearable device configured to be worn by a user whilst in use.

6. The system of claim 1, wherein the plurality of local servers are each further configured to generate store-specific metadata, and wherein the product recall task message comprises the store-specific metadata.

7. The system of claim 6, wherein the store-specific metadata comprises at least one of: a location of the one or more product items in the retail store, and an image of a display unit on which the one or more product items are displayed in the retail store.

8. The system of claim 1, wherein the product recall command message comprises at least one of a priority level, and a deadline for performing the product recall event.

9. A method of supporting operations in retail stores, comprising:
receiving, by a controlling server, a product recall notification message comprising product information that identifies one or more product items;
generating, by the controlling server, a product recall command message in response to the received product recall notification message and transmitting the product recall command message to a plurality of local servers coupled to the controlling server;
producing, by each local server, a product recall task message in response to the received product recall command message and transmitting the product recall task message to an in-store portable device coupled to a respective local server;
providing, by the in-store portable device, an evidence message gathering evidence of a product recall event and transmitting the evidence message to the respective local server; and transmitting, by the local server, the generated evidence message to the controlling server.

10. The method of claim 9, further comprising:
capturing by the in-store portable device at least one evidential image providing evidence of the product recall event, and
including the at least one evidential image in the evidence message.

11. The method of claim 10, further comprising:
generating image metadata associated with the at least one evidential image, and including the generated image metadata in the evidence message.

12. The method of claim 11, wherein the image metadata includes at least one of a time at which the evidential image was captured and a location in the retail store at which the evidential image was captured.

13. The method of claim 10, further comprising:
capturing the at least one evidential image before the product recall event has occurred.

14. The method of claim 10, further comprising:
capturing the at least one evidential image after the product recall event has occurred.

15. The method of claim 9, wherein the in-store portable device comprises a wearable device worn by a user whilst in use.

16. The method of claim 9, further comprising:
generating, by each of the plurality of local servers, store-specific metadata, and including the store-specific metadata in the product recall task message.

17. The method of claim 16, wherein the store-specific metadata comprises at least one of a location of the one or more product items in the retail store, and an image of a display unit on which the one or more product items are displayed in the retail store.

18. The method of claim 9, wherein the product information comprises at least one of the retailer's stock keeping number (SKU), a batch number of the recalled product, and a description of the fault in the product.

19. The method of claim 9, wherein the product recall command message comprises at least one of a priority level and a deadline for performing the product recall event.

20. A computer readable medium having instructions recorded thereon which when executed by a computer device causes the computer device to contribute in a method of supporting operations in retail stores, comprising:
receiving, by a controlling server, a product recall notification message comprising product information that identifies one or more product items;
generating, by the controlling server, a product recall command message in response to the received product recall notification message and transmitting the product recall command message to a plurality of local servers coupled to the controlling server;
producing, by each local server, a product recall task message in response to the received product recall command message and transmitting the product recall task message to an in-store portable device coupled to a respective local server;
providing, by the in-store portable device, an evidence message gathering evidence of a product recall event and transmitting the evidence message to the respective local server; and transmitting, by the local server, the generated evidence message to the controlling server.
